(19) United States
(12) Patent Application Publication
(10) Pub. No.: US 2026/0179475 A1
(43) Pub. Date: Jun. 25, 2026

(54) EXPANDED PROTOCOL FOR SYNCHRONIZING NON-ADDRESSABLE NOTIFICATION APPLIANCES

(71) Applicant: Tyco Fire & Security GmbH, Neuhausen am Rheinfall (CH)

(72) Inventors: Saurabh BAGKAR, Westford, MA (US); Sonali Mahendra DATE, Pune (IN); Joseph D. FARLEY, Warwick, MA (US)

(21) Appl. No.: 19/000,140

(22) Filed: Dec. 23, 2024

(51) Int. Cl. G08B 29/12; G08B 17/00

(52) U.S. Cl. CPC G08B 29/12; G08B 17/00

(57) ABSTRACT

Aspects described herein relate to a notification appliance that can receive, from a notification appliance circuit (NAC) and using the interface, a synchronization pulse signal including a command signal indicating a synchronized candela rating (or other settings), and can modify, based on the command signal, a candela rating stored at the notification appliance for operating the strobe light to be equal to the synchronized candela rating. Other aspects relate to a fire alarm control panel (FACP) that can transmit the synchronization pulse signal including a command signal indicating the synchronized candela rating (or other settings).

### FIELD

The present disclosure relates generally to fire-alarm control systems, and more particularly, to configuring non-addressable notification appliances in fire-alarm control systems.

### BACKGROUND

Fire alarm control panels (FACPs) are provided in buildings for communicating with notification appliances, such as strobes, horns, or other devices, for alerting of detected fire, carbon monoxide, or other hazards. An FACP can receive, from one or more detectors capable of detecting fire, carbon monoxide, or other hazards, an indication of the detected condition, based on which the FACP can signal a notification appliance to alert of the detected condition by activating a strobe, sounding a piezoelectric horn, etc. The notification appliances can include non-addressable notification appliances that are coupled to a notification appliance circuit (NAC), operated by the FACP, over which the non-addressable notification appliances can receive signals transmitted by the FACP. The conventional non-addressable notification appliances can receive and process the signals to operate one or more functions based on commands indicated in the signals without being able to provide feedback over the NAC. The non-addressable notification appliances are typically less expensive to obtain and install than addressable notification appliances, but also provide less robust functionality due to the FACP's inability to individually communicate with the non-addressable notification appliances.

### SUMMARY

The following presents a simplified summary of one or more aspects in order to provide a basic understanding of such aspects. This summary is not an extensive overview of all contemplated aspects and is intended to neither identify key or critical elements of all aspects nor delineate the scope of any or all aspects. Its sole purpose is to present some concepts of one or more aspects in a simplified form as a prelude to the more detailed description that is presented later.

According to one or more aspects, a notification appliance is provided that includes one or more processors for operating a strobe light, and an interface for coupling the notification appliance to a notification appliance circuit (NAC) as a non-addressable notification appliance to receive command signals from a fire alarm control panel (FACP). The one or more processors are configured to receive, from the NAC and using the interface, a synchronization pulse signal including a command signal indicating a synchronized candela rating, and modify, based on the command signal, a candela rating stored at the notification appliance for operating the strobe light to be equal to the synchronized candela rating.

In another aspect, a method for modifying a candela rating of a notification appliance is provided that includes receiving, from a NAC to which the notification appliance is coupled, a synchronization pulse signal including a command signal indicating a synchronized candela rating, and modifying, based on the command signal, a candela rating stored at the notification appliance for operating the strobe light to be equal to the synchronized candela rating.

In another aspect, a fire alarm control panel (FACP) is provided that includes one or more processors, and a notification appliance interface configured for coupling to a NAC to transmit command signals to non-addressable notification appliances. The one or more processors are configured to transmit, to the NAC and using the interface, a synchronization pulse signal including a command signal indicating a synchronized candela rating for the non-addressable notification appliances.

In another aspect, a method for configuring non-addressable notification appliances on a NAC is provided that includes generating a synchronization pulse signal including a command signal indicating a synchronized candela rating for the non-addressable notification appliances, and transmitting the synchronization pulse signal to the NAC.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, wherein dashed lines may indicate optional elements, and in which:

FIG. 1 illustrates a schematic diagram of an example of a fire notification system, in accordance with aspects described herein;

FIG. 2 illustrates an example of signaling from a fire alarm control panel (FACP) to notification appliances, including synchronization pulses, in accordance with aspects described herein;

FIG. 3 illustrates examples of signal patterns that can be transmitted to indicate bit patterns, in accordance with aspects described herein;

FIG. 4 illustrates an example of a method for modifying a candela rating of a notification appliance based on a synchronization pulse signal, in accordance with aspects described herein; and

FIG. 5 illustrates an example of a method for transmitting a synchronization pulse signal indicating a command signal to indicate a candela rating, in accordance with aspects described herein.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

Existing notification appliances connected on fire alarm control panel (FACP) operate on a reverse polarity Notification Appliance Circuit (NAC). When this NAC is in the reverse polarity, or supervision state, notification appliances may not operate and may reflect a high impedance to the NAC. The notification appliances can be activated and can operate when the panel changes NAC to forward polarity in alarm condition. For example, a notification appliances can power up, based on receiving a signal from the FACP via the NAC, and can prepare to flash when it detects a strobe synchronization signal on the NAC. The FACP can also send pulse signals that can include some audible command signals such as Turn-ON, Turn-OFF, March time, and temporal, to control a piezoelectric horn of the notification appliances. Unlike addressable notification appliances, conventional non-addressable notification appliances cannot be controlled through FACP for certain settings, such as candela rating. Rather, the conventional non-addressable notification appliances have a hardware control unit, such as an onboard switch, used to select the candela rating.

Aspects described herein relate to extending a protocol used for generating, transmitting, receiving, and/or processing synchronization pulse signals to allow for additional settings for the non-addressable notification appliances to be configured by the FACP, such as candela rating. For example, the protocol for a synchronization pulse signal can be extended to include additional command signals or corresponding bit patterns in a synchronization pulse to indicate one or more of a synchronized candela rating, initiation of a self-test function, and/or the like. In this regard, for example, the FACP can generate and transmit, over the NAC, a synchronization pulse signal including an additional command signal to indicate synchronized candela rating, initiation of a self-test function, etc. The non-addressable notification appliances can include a configurable hardware unit, such as a mechanical switch, to indicate functionality to receive and configure the synchronized candela rating or to indicate a specific candela rating.

Extending the protocol used for the synchronization pulse signals, in this regard, can allow for synchronizing a candela rating among non-addressable notification appliances that support the feature without disrupting legacy notification appliances that may not support the feature. In addition, in an example, non-addressable notification appliances that support the feature can be configured by a configurable hardware unit to either accept the synchronized candela rating or to set a specific candela rating regardless of the synchronized candela rating. This can facilitate streamlined configuration of non-addressable notification appliance through synchronized candela rating setting for most notification appliances, while allowing manual setting of outlier notification appliances. In addition, self-test can be concurrently initiated on the multiple non-addressable notification appliances that support the feature through specific command signaling in the synchronization pulse signals.

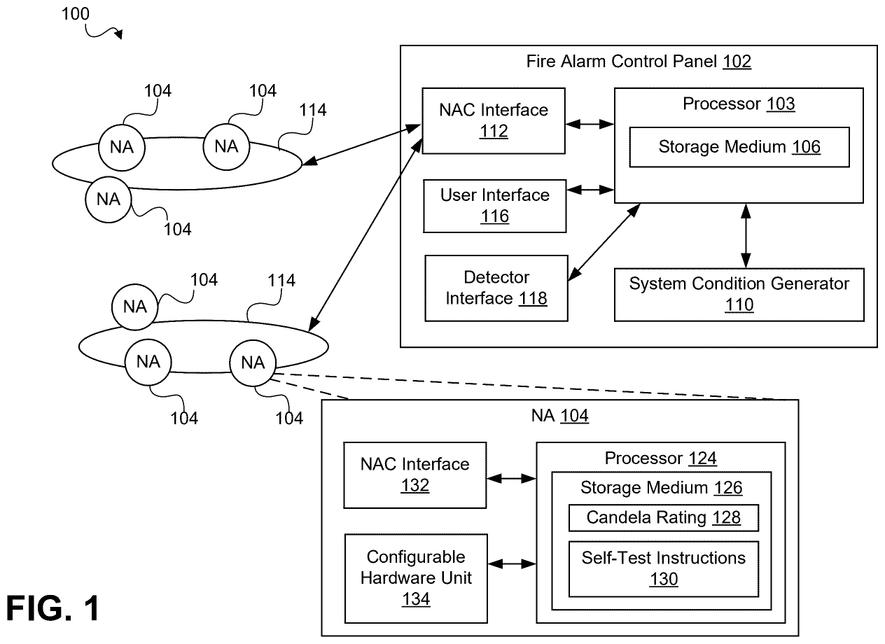

Referring now to FIG. 1, a fire notification system 100, also referred to as a fire alarm system, is shown, in accordance with aspects described herein. Fire notification system 100 can provide notification of a detected fire, carbon monoxide level, or other hazards. For example, fire notification system 100 can include a FACP 102 for communicating with various detection devices (not shown) and/or notification appliances 104 to detect and notify of detected fires, carbon monoxide levels, or other hazards. The FACP can include one or more processors 103 for operating instructions stored on a storage medium 106 for detecting and/or notifying of detected hazards.

The one or more processors 103 can communicate, through a NAC interface 112, with one or more notification appliances 104 via a communication link. Although the notification appliances 104 can be connected radially from the NAC interface 112, groups of notification appliances can be connected in series on a NAC 114 or other loop with the ends of the NAC 114 meeting at the NAC interface 112. In an example, more than one NAC 114 can be connected at the NAC interface 112. In accordance with aspects, described herein, the FACP 102 can transmit signals to the notification appliances 104 over the NAC 114, using NAC interface 112, to cause the notification appliances 104 to activate a strobe or alarm to notify of detected hazards.

Similarly, in an example, the one or more processors 103 can communicate, through a detector interface 118, with one or more detectors (not shown) via a communication link. The detectors can be similarly coupled to the FACP 102 via a circuit or loop that terminates at the FACP 102 at both ends. In an example, the one or more processors 103 may include a system condition generator 110 for generating a system condition, such as a notification via notification appliances 104, based on a detected condition. In another example, FACP 102 can include a user interface 116 to facilitate configuration of the FACP 102 and/or by which the FACP 102 can communicate information regarding the detectors or notification appliances 104 in the fire detection system 100.

In an example, each detector in the system can be provided with a sensing element, or sensor, which can sense a particular parameter which relates to the detected conditions at the location of the detector, and/or can transmit a detector value indicative of the sensed parameter to the FACP 102 in a sensor signal. The parameter that is to be measured can be dependent on the specific conditions to be measured at the location of the detector, and/or the particular use to which the detector is put. For example, if the sensor is an optical smoke detector, it can transmit signals including detector values corresponding to the amount of obscuration caused by smoke at the location of that detector, the percentage of obscuration being the parameter which is an indication of the amount of smoke at that location, and/or the like. A temperature sensor can transmit a signal having a detector value indicative of the temperature at the location of the detector, where the temperature is the parameter. A carbon monoxide detector can transmit a signal having a detector value indicative of the carbon monoxide level at the location of the detector, where the carbon monoxide level is the parameter

The signals including the detector values relating to the parameters that are measured by the sensing elements within the detector can be transmitted to the FACP 102 and received by the detector interface 118. The detector interface 118 can control and manage the signals sent to and received from the detectors, and/or can transmit the signals received from the detectors, or associated values, to the one or more processors 103. In one example, a loop processor can be used to time-multiplex the incoming detector values from all of the detectors at high frequency, so that the integrity of the system is known to a resolution of a matter of a few seconds, and the loop processor can pass the data to the one or more processors 103.

In an example, the system condition generator 110 can receive and analyze the output values from the detector interface 118 (and/or from an associated loop processor), and/or can provide the one or more processors 103 with information relating to the status of the detection system based on the signals received from the detector interface 118. The system condition generated can include a fault condition if a fault has been detected, an alarm condition if detector values indicate that a parameter detected by a sensor element is outside a normal range, a normal condition if the system is operating normally with no fire (or other hazard) detected, etc. When the system condition generator 110 detects a system condition based on received detector values, system condition generator 110 can generate a notification signal for transmitting, via NAC interface 112 on the NAC(s) 114 to operate notification appliances 104 to notify of the detected condition (e.g., by activating a strobe and/or horn of the notification appliances 104).

In an example, the notification appliances 104 can include one or more processors 124 for receiving command signals via NAC 114 and performing one or more functions based on the command signals, such as activating a strobe or horn to notify of detected hazards. The one or more processors 124 can include a storage medium 126 that can store a synchronized candela rating 128 to use when activating a strobe (not shown) and/or self-test instructions 130 for performing a self-test function. In addition, for example, the notification appliance 104 can include a NAC interface 132 for receiving signals from the NAC 114, and/or a configurable hardware unit 134 for manually setting a candela rating for the strobe (e.g., which can override a synchronized candela rating received via a command signal on the NAC 114).

In accordance with aspects described herein, the one or more processors 103 can generate a command signal for transmitting in a synchronization pulse signal, where the command signal indicates a configuration for a synchronized candela rating for non-addressable notification appliances. For example, the one or more processors 103 can generate the command signal, and/or transmit the command signal on the NAC 114 via NAC interface 112, using varying voltage to indicate the configured candela rating, as described herein. In this example, notification appliances 104 can receive the synchronization pulse signal on the NAC 114 via NAC interface 132, and if the configurable hardware unit 134 is set to store the synchronized candela rating, the one or more processors 124 can store the synchronized candela rating as candela rating 128 in the storage medium 126. The notification appliance 104 can subsequently operate a strobe at the candela rating 128 when a strobe signal is received on the NAC 114.

In another example, the one or more processors 103 can generate a command signal for transmitting in a synchronization pulse signal, where the command signal indicates performing a self-test function for non-addressable notification appliances. For example, the one or more processors 103 can generate the command signal, and/or transmit the command signal on the NAC 114 via NAC interface 112, using varying voltage to indicate performing the self-test function, as described herein. In this example, notification appliances 104 can receive the synchronization pulse signal on the NAC 114 via NAC interface 132, and the one or more processors 124 can execute the self-test instructions 130 stored in the storage medium 126 to perform the self-test operation.

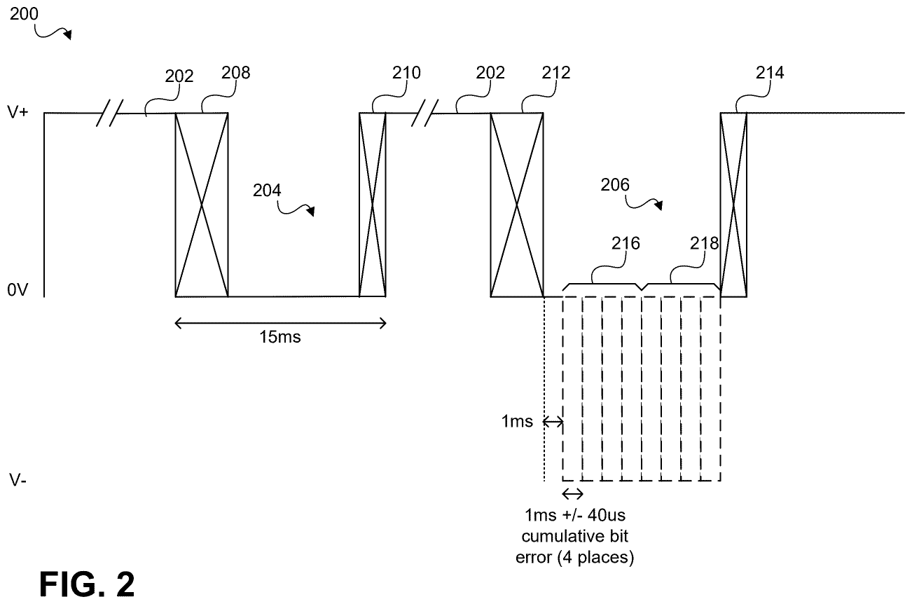

FIG. 2 illustrates an example of signaling 200 from a FACP to notification appliances, including synchronization pulses, in accordance with aspects described herein. The signaling 200 can include nominal voltage applied (e.g., around 33 volts), by the FACP 102 to the NAC 114, which the notification appliances 104 can receive and process, as described herein. The signaling 200 includes a positive voltage signal 202 for a period of time, which can cause the notification appliances 104 to power up and prepare for operation when other signaling is received. In an example, signaling 200 can subsequently include a time period of 15 milliseconds (ms) including a relay operate and bounce 208, a period of zero (or near zero) voltage 204 (which can have a minimum time period, such as 8 ms), and a relay release and bounce 210. This can represent a synchronization pulse without a command signal.

The positive voltage signal 202 can continue for a period of time (e.g., 980 ms+/−10 ms), after which another synchronization pulse can be received. This synchronization pulse can similarly be defined by a relay operate and bounce 212, a period of zero (or near zero) or negative voltage 206 (which can have a minimum time period, such as 9 ms), and a relay release and bounce 214. This synchronization pulse can include one or more command signals including possible 1 ms negative voltage signals (e.g., around-33 volts) to convey commands or settings for the notification appliances 104. The time periods for possible 1 ms negative voltage signals can be grouped into a first set of time periods 216, which can correspond to legacy audible commands such as Horn-ON, Horn-OFF, March time, and temporal, and a second set of time periods 218, which can correspond to additional settings, such as candela rating, self-test initiation, etc., as described herein.

For example, the second set of time periods 218 can include four time periods for sending signals to indicate 4 bits (e.g., 0 or 1, indicated by zero voltage or negative voltage). In one specific example, bit patterns can be indicated by signaling in the second set of time periods 218 to indicate certain candela ratings, self-test, etc. One example of bit patterns mapped to candela ratings or other functions is shown below:

| Bit Pattern | Candela |
|---|---|
| 0001 | 15 cd |
| 0010 | 30 cd |
| 0011 | 75 cd |
| 0100 | 110 cd |
| 0101 | 135 cd |
| 0110 | 185 cd |
| 0111 | Reserved |
| 1XXX | Self-Test |

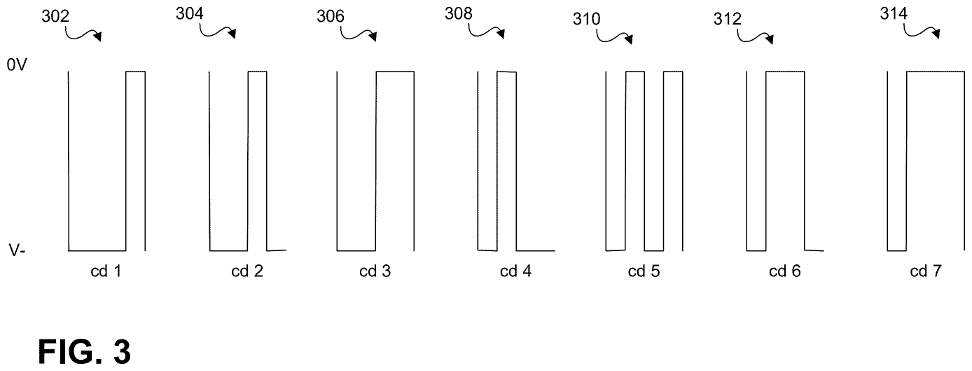

An example of sending signaling using zero voltage or negative voltage to indicate a bit pattern is shown in FIG. 3.

FIG. 3 illustrates examples of signal patterns 302, 304, 306, 308, 310, 312, 314 that can be transmitted to indicate bit patterns, in accordance with aspects described herein. For example, the FACP 102 can transmit on NAC 114, and/or the notification appliances 104 can receive on the NAC 114, the command signal in the second set of time periods 218, which can be transmitted according to one of the signal patterns 302, 304, 306, 308, 310, 312, 314, which can indicate a bit pattern corresponding to a candela setting. For example, the one of the signal patterns 302, 304, 306, 308, 310, 312, 314 can indicate the bit patterns by alternating between zero (or near zero) volts and negative voltage. In an example, signal pattern 302 can indicate bit pattern 0001, which can correspond to a first candela rating (cd 1), signal pattern 304 can indicate bit pattern 0010, which can correspond to a second candela rating (cd 2), signal pattern 306 can indicate bit pattern 0011, which can correspond to a third candela rating (cd 3), signal pattern 308 can indicate bit pattern 0100, which can correspond to a fourth candela rating (cd 4), signal pattern 310 can indicate bit pattern 0101, which can correspond to a fifth candela rating (cd 5), signal pattern 312 can indicate bit pattern 0110, which can correspond to a sixth candela rating (cd 6), and signal pattern 314 can indicate bit pattern 0111, which can correspond to a seventh candela rating (cd 7). In an example, the command signal in the second set of time periods 218 can be used to indicate other settings.

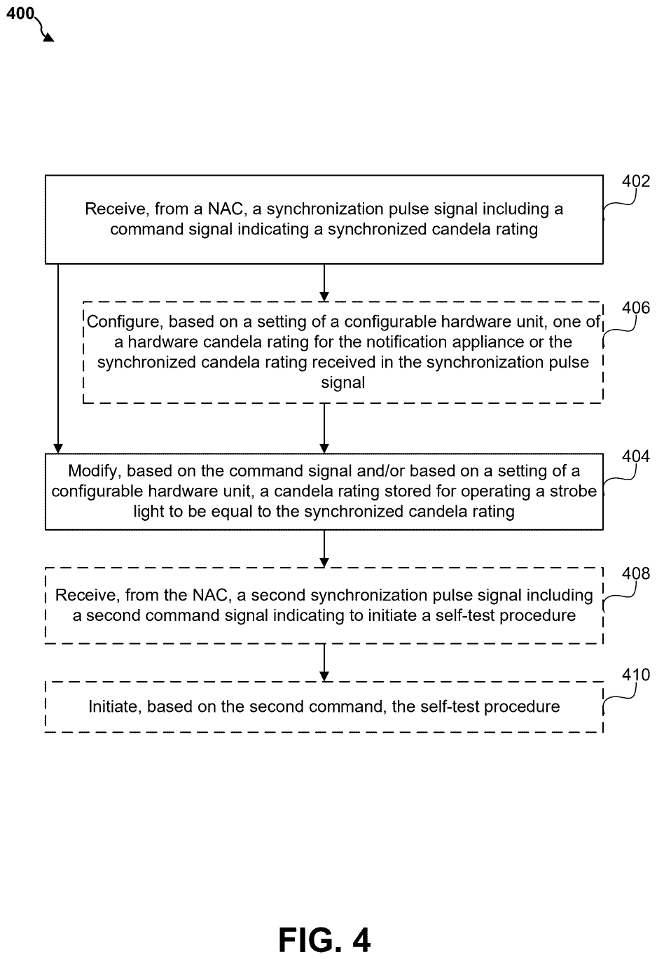

FIG. 4 illustrates an example of a method 400 for modifying a candela rating of a notification appliance based on a synchronization pulse signal, in accordance with aspects described herein. For example, a notification appliance 104 can perform the method 500 using one or more components described in FIG. 1 above.

For example, in method 400, at action 402, a synchronization pulse signal including a command signal indicating a synchronized candela rating can be received from a NAC. In an aspect, NAC interface 132 of a notification appliance 104, e.g., in conjunction with the one or more processors 124, storage medium 126, etc., can receive, from the NAC (e.g., NAC 114), the synchronization pulse signal including the command signal indicating the synchronized candela rating. For example, the synchronization pulse signal can be similar to that shown in FIG. 2, which can include a period of zero (or near zero) or negative voltage 206 to indicate one or more command signals. The start of the synchronization pulse signal can be defined by the relay operate and bounce 212, after which the NAC interface 132 and/or one or more processors 124 can monitor for one or more negative voltage signals (or positive voltage signals) and/or zero voltage signals to indicate bit patterns in the command signals, such as in the first set of time periods 216 or the second set of time periods 218.

For example, in method 400, at action 404, a candela rating stored for operating a strobe light can be modified, based on the command signal and/or based on a setting of a configurable hardware unit, to be equal to the synchronized candela rating. In an aspect, the one or more processors 124 of a notification appliance 104, e.g., in conjunction with storage medium 126, etc., can modify, based on the command signal and/or based on a setting of a configurable hardware unit, the candela rating stored for operating a strobe light to be equal to the synchronized candela rating. For example, the command signal can include time periods of negative voltage or zero voltage (or positive voltage) to indicate a pattern of bit values (e.g., bit value 0 for zero voltage or bit value 1 for negative (or positive) voltage). The series of bits can indicate a candela rating, as described in one example in FIG. 3 above. The one or more processors 103 can determine the candela rating indicated by the bit pattern in the command signal, and can accordingly update the candela rating 128 stored in the storage medium 126. The notification appliance 104 can utilize the stored candela rating 128 when operating a strobe to notify of a detected condition (e.g., based on receiving an activation signal on the NAC 114), as described above. In addition, for example, the one or more processors 124 can detect the command signal for candela rating in the second set of time periods 218 and/or can detect an audible command signal in the first set of time periods 216. In an example, the notification appliances 104 can perform functions corresponding to the audible command signal as well.

In one example, in method 400, optionally at action 406, one of a hardware candela rating for the notification appliance or the synchronized candela rating received in the synchronization pulse signal can be configured based on a setting of a configurable hardware unit. In an aspect, the one or more processors 124 of a notification appliance 104, e.g., in conjunction with storage medium 126, etc., can configure, based on the setting of the configurable hardware unit, one of the hardware candela rating for the notification appliance or the synchronized candela rating received in the synchronization pulse signal. For example, the notification appliances 104 can have a configurable hardware unit 134, as described, such as a switch that can be activated in multiple positions, where one position indicates to use the synchronized candela rating received in the synchronization pulse signal and other positions indicate specific hardware candela ratings to use instead of the synchronized candela rating received in the synchronization pulse signal. If the notification appliance 104 is configured through the configurable hardware unit 134 to operate as per one of the hardware configurable candela ratings, the notification appliance 104 can ignore the synchronized candela rating received in the synchronization pulse signal.

For example, in method 400, optionally at action 408, a second synchronization pulse signal including a second command signal indicating to initiate a self-test procedure can be received from a NAC. In an aspect, NAC interface 132 of a notification appliance 104, e.g., in conjunction with the one or more processors 124, storage medium 126, etc., can receive, from the NAC (e.g., NAC 114), the second synchronization pulse signal including the second command signal indicating to initiate the self-test procedure. For example, the second synchronization pulse signal can be similar to that shown in FIG. 2, which can include a period of zero (or near zero) or negative voltage 206 to indicate the second command signal. The start of the synchronization pulse signal can be defined by the relay operate and bounce 212, after which the NAC interface 132 and/or one or more processors 124 can monitor for negative voltage signals to indicate bit patterns in the second command signal (e.g., in the second set of time periods 218).

For example, in method 400, optionally at action 410, a self-test procedure can be initiated based on the second command signal. In an aspect, the one or more processors 124 of a notification appliance 104, e.g., in conjunction with storage medium 126, etc., can initiate, based on the second command the self-test procedure by executing the self-test instructions 130 stored in the storage medium 126. For example, the self-test procedure can include activating the strobe at the stored or hardware configured candela rating, sounding a horn based on an audible command signal, activating a light emitting diode (LED) light to indicate the self-test procedure status (e.g., pass or fail), and/or the like.

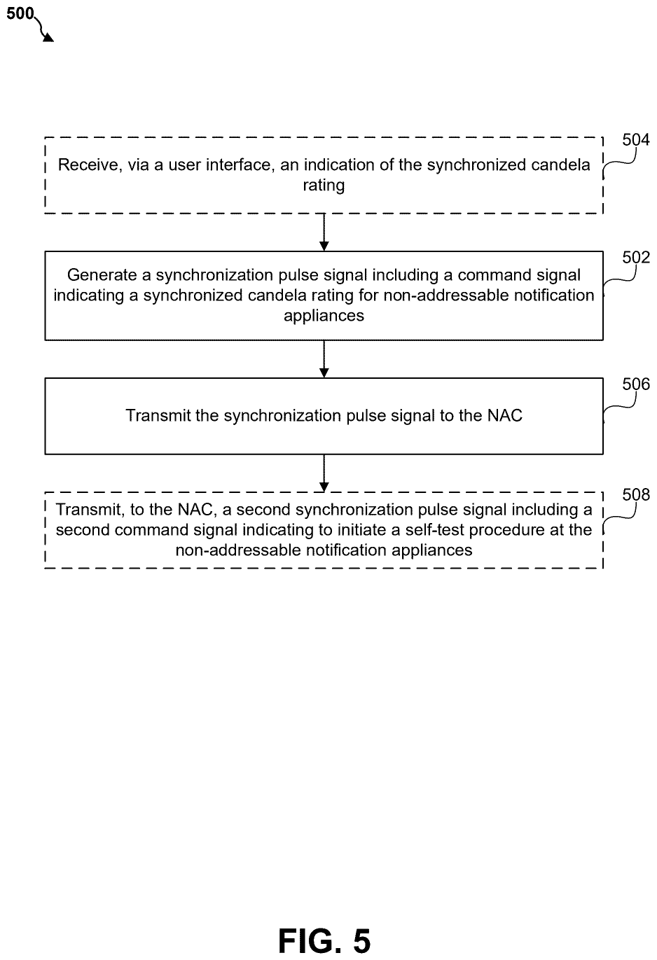

FIG. 5 illustrates an example of a method 500 for transmitting a synchronization pulse signal indicating a command signal to indicate a candela rating, in accordance with aspects described herein. For example, a FACP 102 can perform the method 500 using one or more components described in FIG. 1 above.

For example, in method 500, at action 502, a synchronization pulse signal including a command signal indicating a synchronized candela rating for non-addressable notification appliances can be generated. In an aspect, one or more processors 103 of a FACP 102, e.g., in conjunction with the storage medium 106, etc., can generate the synchronization pulse signal including the command signal indicating the synchronized candela rating for non-addressable notification appliances. For example, the synchronization pulse signal can be similar to that shown in FIG. 2, which can include a period of zero (or near zero) or negative voltage 206 to indicate one or more command signals. The start of the synchronization pulse signal can be defined by the relay operate and bounce 212, and can include one or more negative voltage signals (or positive voltage signals) and/or zero voltage signals to indicate bit patterns in the command signals, such as in the first set of time periods 216 or the second set of time periods 218. The second set of time periods 218 can be used to indicate the synchronized candela rating, as described herein.

In one example, in method 500, optionally at action 504, an indication of the synchronized candela rating can be received via a user interface. In an aspect, the one or more processors 103 of a FACP 102, e.g., in conjunction with storage medium 106, etc., can receive, via the user interface (e.g., user interface 116), the indication of the synchronized candela rating. For example, the FACP 102 or a corresponding application that can interact with the FACP 102 can display a user interface 116 to allow a user to specify settings for the FACP 102 by interacting with the user interface 116. For example, the user can input a synchronized candela rating in a text box, specify the synchronized candela rating in a configuration file for configuring the FACP 102, and/or the like. In any case, user interface 116 can indicate the synchronized candela rating as a selected one of selectable candela ratings.

For example, in method 500, at action 506, the synchronization pulse signal can be transmitted to the NAC. In an aspect, the NAC interface 112 of the FACP 102, e.g., in conjunction with the one or more processors 103, the storage medium 106, etc., can transmit the synchronization pulse signal to the NAC (e.g., NAC 114), so that the notification appliances 104 can receive and process the synchronization pulse signal to receive the synchronized candela rating, as described.

In one example, in method 500, optionally at action 508, a second synchronization pulse signal including a second command signal indicating to initiate a self-test procedure at the non-addressable notification appliances can be generated and/or transmitted to the NAC. In an aspect, the NAC interface 112 of the FACP 102, e.g., in conjunction with the one or more processors 103, the storage medium 106, etc., can transmit, to the NAC (e.g., NAC 114), the second synchronization pulse signal including the second command signal indicating to initiate the self-test procedure at the non-addressable notification appliances, as described above.

Some further example aspects are provided below.

Aspect 1 is a notification appliance that includes one or more processors for operating a strobe light, and an interface for coupling the notification appliance to a NAC as a non-addressable notification appliance to receive command signals from a FACP. The one or more processors are configured to receive, from the NAC and using the interface, a synchronization pulse signal including a command signal indicating a synchronized candela rating, and modify, based on the command signal, a candela rating stored at the notification appliance for operating the strobe light to be equal to the synchronized candela rating.

In Aspect 2, the notification appliance of Aspect 1 includes a configurable hardware unit for indicating a setting of whether to configure one of a hardware candela rating for the notification appliance or the synchronized candela rating received in the synchronization pulse signal as the candela rating stored at the notification appliance, where the one or more processors are configured to modify the candela rating based on the setting indicated by the configurable hardware unit.

In Aspect 3, the notification appliance of any of Aspects 1 or 2 includes where the command signal also indicates a synchronized horn setting for operating a piezoelectric horn of the notification appliance.

In Aspect 4, the notification appliance of any of Aspects 1 to 3 includes where the one or more processors are configured to receive, from the NAC and using the interface, a second synchronization pulse signal including a second command signal indicating to initiate a self-test procedure, and initiate, based on the second command, the self-test procedure.

In Aspect 5, the notification appliance of any of Aspects 1 to 4 includes where the command signal indicates the synchronized candela rating based on applying a negative voltage at one or more time periods during the synchronization pulse signal to indicate a series of bits, and where the one or more processors are configured to determine the synchronized candela rating based on the series of bits.

Aspect 6 is a method for modifying a candela rating of a notification appliance that includes receiving, from a NAC to which the notification appliance is coupled, a synchronization pulse signal including a command signal indicating a synchronized candela rating, and modifying, based on the command signal, a candela rating stored at the notification appliance for operating a strobe light to be equal to the synchronized candela rating.

In Aspect 7, the method of Aspect 6 includes configuring, based on a setting of a configurable hardware unit, one of a hardware candela rating for the notification appliance or the synchronized candela rating received in the synchronization pulse signal as the candela rating stored at the notification appliance.

In Aspect 8, the method of any of Aspects 6 or 7 includes where the command signal also indicates a synchronized horn setting for operating a piezoelectric horn of the notification appliance.

In Aspect 9, the method of any of Aspects 6 to 8 includes receiving, from the NAC, a second synchronization pulse signal including a second command signal indicating to initiate a self-test procedure, and initiating, based on the second command, the self-test procedure.

In Aspect 10, the method of any of Aspects 6 to 9 includes where the command signal indicates the synchronized candela rating based on applying a negative voltage at one or more time periods during the synchronization pulse signal to indicate a series of bits, and determining the synchronized candela rating based on the series of bits.

Aspect 11 is a FACP including one or more processors, and a notification appliance interface configured for coupling to a notification appliance circuit to transmit command signals to non-addressable notification appliances. The one or more processors are configured to transmit, to the NAC and using the interface, a synchronization pulse signal including a command signal indicating a synchronized candela rating for the non-addressable notification appliances.

In Aspect 12, the FACP of Aspect 11 includes where the command signal also indicates a synchronized horn setting for operating a piezoelectric horn of the non-addressable notification appliances.

In Aspect 13, the FACP of any of Aspects 11 or 12 includes where the one or more processors are configured to transmit, to the NAC and using the interface, a second synchronization pulse signal including a second command signal indicating to initiate a self-test procedure at the non-addressable notification appliances.

In Aspect 14, the FACP of any of Aspects 11 to 13 includes where the command signal indicates the synchronized candela rating based on applying a negative voltage at one or more time periods during the synchronization pulse signal to indicate a series of bits.

In Aspect 15, the FACP of any of Aspects 11 to 14 includes a user interface configured to display selectable candela ratings for configuring the non-addressable notification appliances.

In Aspect 16, the FACP of Aspect 15 includes where the user interface is configured to receive, from interaction with the user interface, an indication of a selected one of the selectable candela ratings, and where the one or more processors are configured to transmit the command signal indicating the synchronized candela rating as the selected one of the selectable candela ratings.

Aspect 17 is a method for configuring non-addressable notification appliances on a NAC including generating a synchronization pulse signal including a command signal indicating a synchronized candela rating for the non-addressable notification appliances, and transmitting the synchronization pulse signal to the NAC.

In Aspect 18, the method of Aspect 17 includes where the command signal also indicates a synchronized horn setting for operating a piezoelectric horn of the non-addressable notification appliances.

In Aspect 19, the method of any of Aspects 17 or 18 includes transmitting, to the NAC, a second synchronization pulse signal including a second command signal indicating to initiate a self-test procedure at the non-addressable notification appliances.

In Aspect 20, the method of any of Aspects 17 to 19 includes where the command signal indicates the synchronized candela rating based on applying a negative voltage at one or more time periods during the synchronization pulse signal to indicate a series of bits.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, a processor, at least one processor, and/or one or more processors, individually or in combination, configured to perform or operable for performing a plurality of actions is meant to include at least two different processors able to perform different, overlapping or non-overlapping subsets of the plurality actions, or a single processor able to perform all of the plurality of actions. In one non-limiting example of multiple processors being able to perform different ones of the plurality of actions in combination, a description of a processor, at least one processor, and/or one or more processors configured or operable to perform actions X, Y, and Z may include at least a first processor configured or operable to perform a first subset of X, Y, and Z (e.g., to perform X) and at least a second processor configured or operable to perform a second subset of X, Y, and Z (e.g., to perform Y and Z). Alternatively, a first processor, a second processor, and a third processor may be respectively configured or operable to perform a respective one of actions X, Y, and Z. It should be understood that any combination of one or more processors each may be configured or operable to perform any one or any combination of a plurality of actions.

As used herein, a storage medium or media, a memory, at least one memory, and/or one or more memories, individually or in combination, configured to store or having stored thereon instructions executable by one or more processors for performing a plurality of actions can include at least two different memories able to store different, overlapping or non-overlapping subsets of the instructions for performing different, overlapping or non-overlapping subsets of the plurality actions, or a single memory able to store the instructions for performing all of the plurality of actions. In one non-limiting example of one or more memories, individually or in combination, being able to store different subsets of the instructions for performing different ones of the plurality of actions, a description of a memory, at least one memory, and/or one or more memories configured or operable to store or having stored thereon instructions for performing actions X, Y, and Z may include at least a first memory configured or operable to store or having stored thereon a first subset of instructions for performing a first subset of X, Y, and Z (e.g., instructions to perform X) and at least a second memory configured or operable to store or having stored thereon a second subset of instructions for performing a second subset of X, Y, and Z (e.g., instructions to perform Y and Z). Alternatively, a first memory, and second memory, and a third memory may be respectively configured to store or have stored thereon a respective one of a first subset of instructions for performing X, a second subset of instruction for performing Y, and a third subset of instructions for performing Z. It should be understood that any combination of one or more memories each may be configured or operable to store or have stored thereon any one or any combination of instructions executable by one or more processors to perform any one or any combination of a plurality of actions. Moreover, one or more processors may each be coupled to at least one of the one or more memories and configured or operable to execute the instructions to perform the plurality of actions. For instance, in the above non-limiting example of the different subset of instructions for performing actions X, Y, and Z, a first processor may be coupled to a first memory storing instructions for performing action X, and at least a second processor may be coupled to at least a second memory storing instructions for performing actions Y and Z, and the first processor and the second processor may, in combination, execute the respective subset of instructions to accomplish performing actions X, Y, and Z. Alternatively, three processors may access one of three different memories each storing one of instructions for performing X, Y, or Z, and the three processor may in combination execute the respective subset of instruction to accomplish performing actions X, Y, and Z. Alternatively, a single processor may execute the instructions stored on a single memory, or distributed across multiple memories, to accomplish performing actions X, Y, and Z.

It will be appreciated that various implementations of the above-disclosed and other features and functions, or alternatives or varieties thereof, may be desirably combined into many other different systems or applications. Also that various presently unforeseen or unanticipated alternatives, modifications, variations, or improvements therein may be subsequently made by those skilled in the art which are also intended to be encompassed by the following claims.

It should be understood that the application is not limited to the details or methodology set forth in the following description or illustrated in the figures. It should also be understood that the phraseology and terminology employed herein is for the purpose of description only and should not be regarded as limiting.

While the exemplary aspects illustrated in the figures and described herein are presently preferred, it should be understood that these aspects are offered by way of example only. Accordingly, the present application is not limited to a particular aspect, but extends to various modifications that nevertheless fall within the scope of the appended claims. The order or sequence of any processes or method steps may be varied or re-sequenced according to alternative aspects.

What is claimed is:

1. A notification appliance, comprising:
one or more processors for operating a strobe light; and
an interface for coupling the notification appliance to a notification appliance circuit (NAC) as a non-addressable notification appliance to receive command signals from a fire alarm control panel (FACP),
wherein the one or more processors are configured to:
receive, from the NAC and using the interface, a synchronization pulse signal including a command signal indicating a synchronized candela rating; and
modify, based on the command signal, a candela rating stored at the notification appliance for operating the strobe light to be equal to the synchronized candela rating.

2. The notification appliance of claim 1, further comprising a configurable hardware unit for indicating a setting of whether to configure one of a hardware candela rating for the notification appliance or the synchronized candela rating received in the synchronization pulse signal as the candela rating stored at the notification appliance, wherein the one or more processors are configured to modify the candela rating based on the setting indicated by the configurable hardware unit.

3. The notification appliance of claim 1, wherein the command signal also indicates a synchronized horn setting for operating a piezoelectric horn of the notification appliance.

4. The notification appliance of claim 1, wherein the one or more processors are configured to:
receive, from the NAC and using the interface, a second synchronization pulse signal including a second command signal indicating to initiate a self-test procedure; and
initiate, based on the second command, the self-test procedure.

5. The notification appliance of claim 1, wherein the command signal indicates the synchronized candela rating based on applying a negative voltage at one or more time periods during the synchronization pulse signal to indicate a series of bits, and wherein the one or more processors are configured to determine the synchronized candela rating based on the series of bits.

6. A method for modifying a candela rating of a notification appliance, comprising:
receiving, from a notification appliance circuit (NAC) to which the notification appliance is coupled, a synchronization pulse signal including a command signal indicating a synchronized candela rating; and
modifying, based on the command signal, a candela rating stored at the notification appliance for operating a strobe light to be equal to the synchronized candela rating.

7. The method of claim 6, further comprising configuring, based on a setting of a configurable hardware unit, one of a hardware candela rating for the notification appliance or the synchronized candela rating received in the synchronization pulse signal as the candela rating stored at the notification appliance.

8. The method of claim 6, wherein the command signal also indicates a synchronized horn setting for operating a piezoelectric horn of the notification appliance.

9. The method of claim 6, further comprising:
receiving, from the NAC, a second synchronization pulse signal including a second command signal indicating to initiate a self-test procedure; and
initiating, based on the second command, the self-test procedure.

10. The method of claim 6, wherein the command signal indicates the synchronized candela rating based on applying a negative voltage at one or more time periods during the synchronization pulse signal to indicate a series of bits, and further comprising determining the synchronized candela rating based on the series of bits.

11. A fire alarm control panel (FACP), comprising:
one or more processors; and
a notification appliance interface configured for coupling to a notification appliance circuit (NAC) to transmit command signals to non-addressable notification appliances,
wherein the one or more processors are configured to transmit, to the NAC and using the interface, a synchronization pulse signal including a command signal indicating a synchronized candela rating for the non-addressable notification appliances.

12. The FACP of claim 11, wherein the command signal also indicates a synchronized horn setting for operating a piezoelectric horn of the non-addressable notification appliances.

13. The FACP of claim 11, wherein the one or more processors are configured to:
transmit, to the NAC and using the interface, a second synchronization pulse signal including a second command signal indicating to initiate a self-test procedure at the non-addressable notification appliances.

14. The FACP of claim 11, wherein the command signal indicates the synchronized candela rating based on applying a negative voltage at one or more time periods during the synchronization pulse signal to indicate a series of bits.

15. The FACP of claim 11, further comprising a user interface configured to display selectable candela ratings for configuring the non-addressable notification appliances.

16. The FACP of claim 15, wherein the user interface is configured to receive, from interaction with the user interface, an indication of a selected one of the selectable candela ratings, and wherein the one or more processors are configured to transmit the command signal indicating the synchronized candela rating as the selected one of the selectable candela ratings.

17. A method for configuring non-addressable notification appliances on a notification appliance circuit (NAC), comprising:
generating a synchronization pulse signal including a command signal indicating a synchronized candela rating for the non-addressable notification appliances; and
transmitting the synchronization pulse signal to the NAC.

18. The method of claim 17, wherein the command signal also indicates a synchronized horn setting for operating a piezoelectric horn of the non-addressable notification appliances.

19. The method of claim 17, further comprising transmitting, to the NAC, a second synchronization pulse signal including a second command signal indicating to initiate a self-test procedure at the non-addressable notification appliances.

20. The method of claim 17, wherein the command signal indicates the synchronized candela rating based on applying a negative voltage at one or more time periods during the synchronization pulse signal to indicate a series of bits.
